(19) United States
(12) Patent Application Publication
(10) Pub. No.: US 2007/0138828 A1
(43) Pub. Date: Jun. 21, 2007

(54) Convertible top system with two rigid roof parts arranged in tandem in their closed position

(76) Inventor: Tobias Wagner, Hamburg (DE)

Correspondence Address: JORDAN AND HAMBURG LLP, 122 EAST 42ND STREET, SUITE 4000, NEW YORK, NY, 10168, US

(21) Appl. No.: 11/642,284

(22) Filed: Dec. 19, 2006

(30) Foreign Application Priority Data
Dec. 19, 2005 (DE) 10 2005 061 201.6

(51) Int. Cl. B60J 7/00

(52) U.S. Cl. 296/108

(57) ABSTRACT

A convertible top system includes at least two rigid top parts with a rear top part being supported at a vehicle body in such a manner that it can swivel and being pivoted with a front top part. A drive unit is provided for each top part for a coordinated opening or closing motion of the two top parts, with at least one drive unit being a piston-cylinder system with one fixed component and one movable component. A fixed component of the piston-cylinder system is mounted at the rear or front top part. A guiding component for a guide unit is rigidly mounted at the fixed component of the piston-cylinder system, with the guide unit being fixed to the movable component of the piston-cylinder system. A bearing for a lever is positioned at the guiding component with the lever being connected to the other of the front or rear top part not mounted to the fixed component on one side and to the other side, a connection piece is coupled between the guiding component and the lever.

### BACKGROUND OF THE INVENTION

The invention relates to a convertible top system with two rigid roof parts arranged in tandem in their closed position according to the generic part of the first claim.

The convertible top systems known are equipped with complex multijoint cinematic arrangements that are normally driven by hydraulic cylinders and transmit the rotating motions by rods to the top parts that are to be moved; see DE 10111705 A1, EP 0749859 A1.

Moreover, the use of swivel motors as actuators is known. They are rigidly mounted at the body and/or they are mounted at the important joint points between the rigid top parts in such a way that they can be moved and they are driven electrically or hydraulically; see EP 1160113 A2.

The motion of the front rigid roof parts of folding tops is initiated via a positively controlled four-joint mechanism the components of which are specifically designed for the corresponding top. A multivalent use of the four-joint mechanism for vehicle tops with other forms or dimensions is not possible. Moreover, the driving torque being effective at the rotation axis is subject to strong variations over the motion travel of the top parts and is particularly low in the end positions of the motion travel. The cinematic components cannot be covered at all or only with high efforts.

Certainly, swivel motors allow reaching the necessary swivel angle and the required constant driving torque, but due to their constructional design they cannot be installed outside the visual range of the top because the rotation axis of the front top part must be arranged at a very low position.

### SUMMARY OF THE INVENTION

It is the object of the present invention to remove the disadvantages just mentioned and to develop a drive system for the individual top parts that has low space requirements, can be easily manufactured and installed, and has a principally independent form and size so that it allows its multivalent use.

### BRIEF DESCRIPTION OF THE INVENTION

According to this invention, this object is realized by the features of the first or second patent claim. Preferable embodiments are subject matter of the dependent claims. Principally, this invention can also be used for convertible car tops that consist of more than two movable rigid parts that are connected with each other. The drive units for the top parts are favorably provided at both sides. In an advantageous embodiment of this invention, the guide is designed as a coulisse in which the element slides like a slide piece. The bearing for the lever that is simultaneously the pivot bearing of the front top part swiveling with the rear top part is located at the coulisse frame laterally to the longitudinal extension of the guide that itself is designed regularly as a straight-line mechanism. The connection piece is principally shorter than the guide. It is part of the invention that the cylinder is moved in relation to the fixed piston, and then it is possible that the guide is connected with the piston and the guided element with the cylinder. A control unit is provided for the simultaneous and coordinated activation of the different drives.

The advantages of this invention are the mostly constant torque at the rotation axis of the front top part, the slim style of the drive unit and its easy integration into the vehicle top, the avoidance of normally usual main rod and the resulting optimum design of the interior rooflining, and finally the big rotation angle (180°) that allows the universal use of the fluid cylinder. Principally, the cylinder-piston combination is based on liquid or gas or is electronically driven.

### BRIEF DESCRIPTION OF THE DRAWINGS

In the following, the invention is explained in more detail by means of schematic drawings. They show:

FIG. 1 an inventive convertible top system,

FIG. 2 the convertible top system in the semi-open position,

FIG. 3 the convertible top system in the open (put down) position,

FIG. 4 the inventive drive in perspective view for the front top part in starting position,

FIG. 5 the drive according to FIG. 4 in the intermediate position according to FIG. 2, and

FIG. 6 the drive according to FIG. 4 in the final position according to FIG. 3.

### DETAILED DESCRIPTION

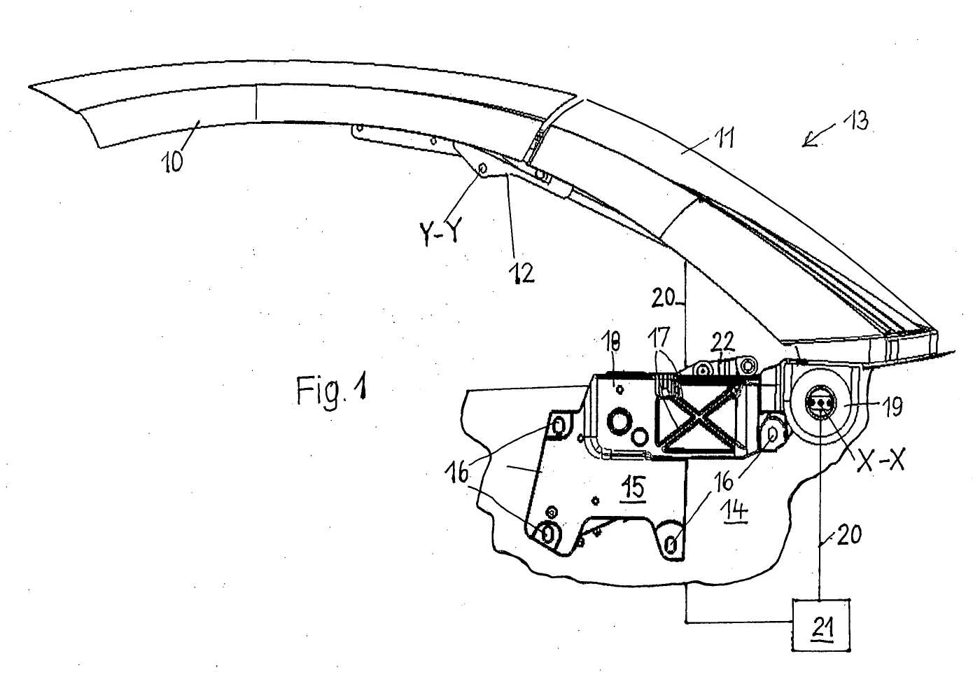

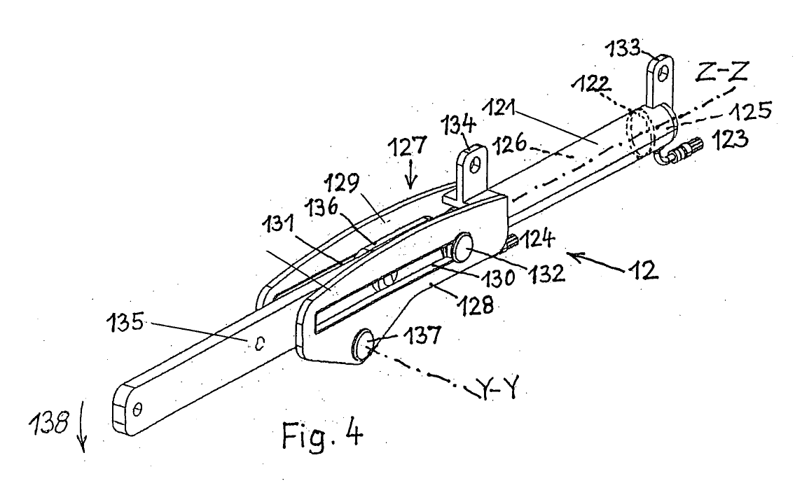

FIG. 1 shows a convertible top system 13 including two rigid top parts 10, 11 and one drive unit 12. Said system is supported at a main bearing 15 at a sketched out body 14 in such a way that it can swivel around an axis X-X that is in perpendicular orientation to the plane of projection. The main bearing 15 is fixed at points 16 with the body 14, for example by a screw connection, and at a console 18 that is provided with stiffening ribs 17 it carries a fluid drive 19 for the rear top part 11 that is rigidly mounted with the fluid drive 19. The fluid drive 19 is controlled by a control unit 21 via lines 20 like the drive unit 12, which is also a fluid drive. The drive unit 12 being explained in more detail in the FIGS. 4 to 6 is rigidly mounted with the two top parts 10, 11 and causes the swiveling motion of the top part 10 relative to the top part 11 around an axis Y-Y that is parallel to the axis X-X. The fluid drive 19 can also be replaced by an electric drive. In this case, the two drive units 12 and 19 are also synchronized by the control unit. In FIG. 1, motion elements 22 are additionally provided for the rear-window shelf that is not shown. It goes without saying that the main bearing 15 and the drive units 12, 19 are provided at both sides of the vehicle body 14.

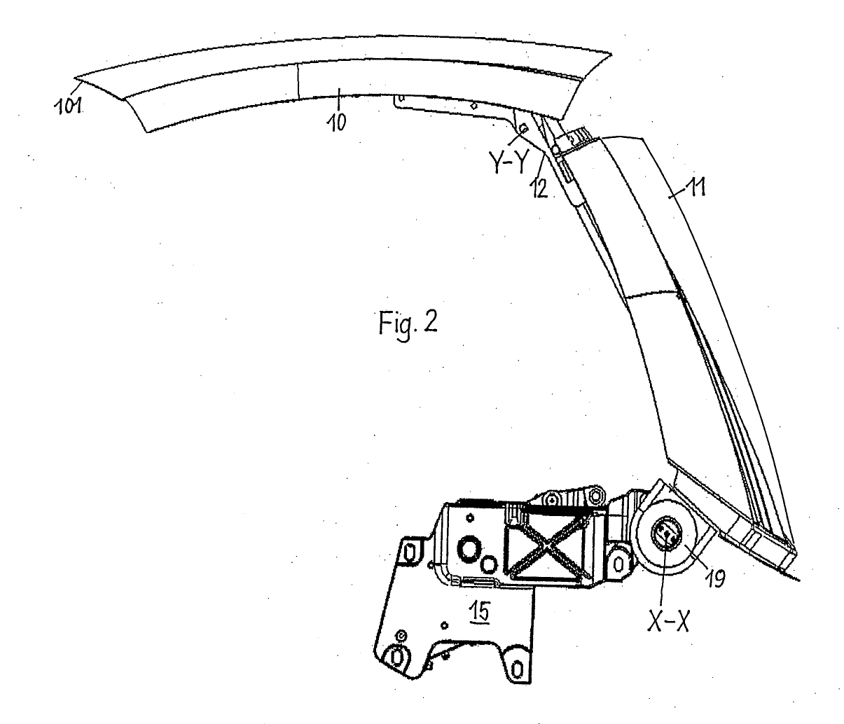

In FIG. 1, the convertible tops system 13 is represented in the starting position, the closed position. FIG. 2 shows a partly opened top system. The rear top part 11 with the fluid drive 19 is clearly swiveled compared to the starting position. Simultaneously, the front top part 10 is swiveled around the axis Y-Y due to the motion-coordination of the control unit 21 that is only represented in FIG. 1. By this swiveling motion, the side 101 of the top part 10 that is positioned away from the top part 11 comes closer to the top part 11 and to the swivel axis X-X. In other words, the convertible top 10, 11 is buckled around the axis Y-Y.

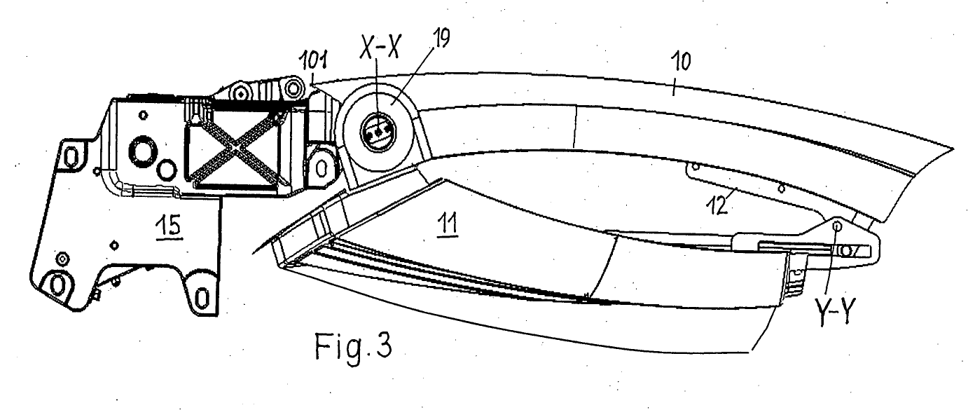

In FIG. 3, the convertible top system 13 has reached the final position of its motion. After its buckling around the movable axis Y-Y, the top part 10 is in an almost anti-parallel position to the top part 11 that itself has been swiveled around the axis X-X by an angle of between 90° and 180°. Here, the side 101 that is positioned away from the top part 10 has come to a position close to the drive 19.

The FIGS. 4 through 6 show the drive unit 12 in the analogous positions to the top parts 10, 11 in the FIGS. 1 through 3. In FIG. 4, a fluid cylinder 121 is provided with an adjustable piston 122 and inlets 123, 124 for a liquid or a gas into the chambers 125, 126 that are formed and varied by the piston 122 in the cylinder 121. At the cylinder 121, a coulisse 127 is rigidly mounted and provided with guiding slots 130, 131 in two legs 128, 129 that are arranged in parallel to each other and to the geometric axis Z-Z of the cylinder 121. Said slots are used for a guide unit 132 that is connected with the piston 122 for example via a not visible rod. Brackets 133, 134 are rigidly mounted with the cylinder 121 or the coulisse 127 and are used to connect the drive unit 12 at the top part 11 in such a way that the cylinder axis Z-Z is positioned mainly in the direction of motion of the top parts 10, 11. At and between the legs 128, 129 a double-armed lever 135 is supported so that it can swivel around the movable axis Y-Y. At its shorter end, this lever 135 is connected to the guide unit 132 and the covered piston rod via a connection piece consisting of two links 136. A bearing bolt 137 that is screwed into the legs 128, 129 below the guiding slots 130, 131 is used to support the double-armed lever 135 between the legs 128, 129. At its longer end, the double-armed lever 135 is rigidly mounted with the top part 10. In this example the whole system is arranged in such a manner that the drive unit 12 and the top parts 10, 11 have a common plane of motion.

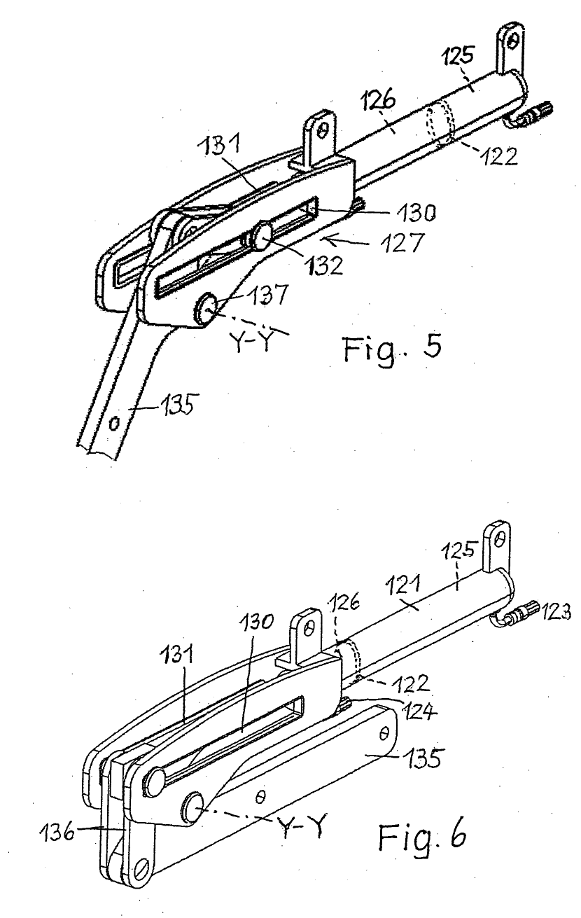

If the convertible top is to be opened, a fluid of a not shown reservoir is pressed through the inlet 123 into the chamber 125 according to the function of the control unit 21 and thus the piston 122 is moved in the cylinder 121 towards the inlet 124. Consequently, the guide unit 132 is moved in the coulisse 127 towards the other end of the guide and the double-armed lever 135, the longer end of which is slightly inclined relative to the axis Z-Z, is further rotated via the links 136 around the axis Y-Y according to an arrow 138. Thus, an intermediate position is reached that is for example represented in FIG. 5. In this position, the guide unit 132 is displaced in the guiding slots 130, 131 so that the links 136 press the shorter end of the double-armed lever 135 out of the coulisse 127 upwards and thus swivel the lever 135 around the bearing bolt 137. If the piston 122 in the cylinder 121 and the guide unit 132 in the guiding slots 130, 131 reach their final positions that can be seen in FIG. 6, the links 136 are mainly in a rectangular position and the lever 135 is mainly in an antiparallel orientation to the axis Z-Z. This fact corresponds to FIG. 3. However, one should consider that synchronously to the swivel motion of the lever 135, the top part 11 at which the drive unit 12 is fixed swivels around the axis X-X in a motion of approximately the same value but in the opposite direction around the axis X-X. Thus, the top part 10 is positioned above the top part 11 in the open position.

If a fluid is pressed into the chamber via the inlet 124, the motion goes in the opposite direction and in the reverse order till the top parts 10, 11 come to their closed position.

It goes without saying that the invention is not bound to the design described. It is for example possible that the piston-cylinder-system is not only driven by a liquid or gas but electrically. Then, the cylinder 121 can be fixed at the top part 10 and the piston 122 can be connected with the top part 11. If the drive unit 12 is adjusted appropriately it is also possible that the cylinder 121 moves relative to the piston 122. It is not required that the final positions of the motion sequence differ by 180° or almost 180°. It is neither necessary that the piece 136 is designed as links nor that the coulisse 127 has two legs; just to mention only some deviating designs of this invention

### LIST OF REFERENCE NUMERALS

10, 11 top parts
12 drive unit
13 convertible top system
14 body
15 main bearing
16 points of the connection
17 stiffening ribs
18 console
19 fluid drive
20 lines
21 control unit
22 motion elements
101 side positioned away
121 fluid cylinder
122 piston
123, 124 inlets
125, 126 chambers
127 coulisse
128, 129 legs
130, 131 guiding slots
132 guide unit
133, 134 brackets
135 lever
136 links
137 bearing bolt
138 arrow
X-X, Y-Y, Z-Z axes

1.-7. (canceled)

8. A convertible top system, comprising:
at least two rigid top parts including a rear top part and a front top part, said rear top part being pivoted with the front top part, said rear top part being supported at a body in such a way that said rear top part can swivel relative to the body;
a drive unit being provided for each of said at least two top parts for a coordinated opening or closing motion of the two top parts, with at least one drive unit being a piston-cylinder system with one fixed component and one movable component, wherein the fixed component of the piston-cylinder system is mounted to the rear top part;
a guide unit being mounted to the movable component of the piston-cylinder system;
a guiding component for cooperating with the guide unit being rigidly mounted to the fixed component of the piston-cylinder system; and
a lever pivotably mounted via a bearing to the guiding component, a first side of said lever being connected with the front top part and a second side of said level being coupled to the guiding component via a connection piece.

9. A convertible top system according to claim 8, wherein the guide unit is a straight-line mechanism.

10. A convertible top system according to claim 9, wherein the guide unit is a slotted link.

11. Convertible top system according to claim 8, wherein the bearing in the guiding component is located below the guide unit.

12. A convertible top system according to claim 8, wherein the connection piece is shorter than the guide unit.

13. A convertible top system according to claim 8, wherein the connection piece comprises two links.

14. A convertible top system, comprising:
at least two rigid top parts including a rear top part and a front top part, said rear top part being pivoted with the front top part, said rear top part being supported at a body in such a way that said rear top part can swivel relative to the body;
a drive unit being provided for each of said at least two top parts for a coordinated opening or closing motion of the two top parts, with at least one drive unit being a piston-cylinder system with one fixed component and one movable component, wherein the fixed component of the piston-cylinder system is mounted to the front top part;
a guide unit being mounted to the movable component of the piston-cylinder system;
a guiding component for cooperating with the guide unit being rigidly mounted to the fixed component of the piston-cylinder system; and
a lever pivotably mounted via a bearing to the guiding component, a first side of said lever being connected with the rear top part and a second side of said lever being coupled to the guiding component via a connection piece.

15. A convertible top system according to claim 14, wherein the guide unit is a straight-line mechanism.

16. A convertible top system according to claim 15, wherein the guide unit is a slotted link.

17. Convertible top system according to claim 14, wherein the bearing in the guiding component is located below the guide unit.

18. A convertible top system according to claim 14, wherein the connection piece is shorter than the guide unit.

19. A convertible top system according to claim 14, wherein the connection piece comprises two links.
